(19) United States
(12) Patent Application Publication
(10) Pub. No.: US 2025/0111569 A1
(43) Pub. Date: Apr. 3, 2025

(54) Engaging Multimodal Content Generation System

(71) Applicants: Northwestern University, Evanston, IL (US); The Trustees of Dartmouth College, Hanover, NH (US)

(72) Inventors: Venkatramanan Siva Subrahmanian, Evanston, IL (US); Chongyang Gao, Evanston, IL (US); Yiren Jian, Evanston, IL (US); Soroush Bosoughi, Evanston, IL (US); Natalia Denisenko, Evanston, IL (US)

(21) Appl. No.: 18/905,400

(22) Filed: Oct. 3, 2024

Related U.S. Application Data
(60) Provisional application No. 63/542,190, filed on Oct. 3, 2023.

(51) Int. Cl. G06T 11/60; G06F 40/279; G06Q 30/0242; G06V 10/74; G06V 10/764; G06V 10/774

(52) U.S. Cl. CPC G06T 11/60; G06F 40/279; G06Q 30/0242; G06V 10/761; G06V 10/764; G06V 10/774

(57) ABSTRACT

Systems and methods described herein include a logical computing framework designed to generate engaging multimodal image-text pairs. For example, this logical computing framework for generating engaging multimodal content (GEM) may be used to create online advertisements that effectively capture users' attention with a blend of images and text. The GEM framework operates in two steps. First, GEM combines a pre-trained engaging discriminator with a method for learning an effective continuous prompt for a stable diffusion model. Next, GEM operates with an iterative algorithm to generate coherent, engaging image-sentence pairs based on a given topic of interest. Results demonstrate that the image-sentence pairs generated by GEM are not only more engaging but also exhibit better alignment compared to several baseline approaches.

### CROSS REFERENCE TO RELATED APPLICATION(S)

This is a utility application claiming priority to an incorporating by reference provisional application entitled “Engaging Multimodal Content Generation System”, Ser. No. 63/542,190 filed Oct. 3, 2023.

### BACKGROUND

Multimodal content has become increasingly important for various applications such as online advertisements, social media posts, and educational materials. In these applications, it is crucial to generate engaging image-text pairs that not only capture the interest of the users, but also ensure the content remains relevant to the topic. For instance, an online advertisement for tourism should highlight an eye-catching image of the natural scenery along with a catchy caption that highlights its features. Similarly, educational material about climate change would benefit from a striking image of a melting glacier accompanied by an informative text that effectively conveys the urgency of the issue.

It is with these concepts in mind, among others, that various aspects of the present disclosure were conceived.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

The GEM framework improves on previous approaches by maximizing the generated content's engagement. The GEM framework includes of two steps. First, GEM combines a pretrained engagement discriminator with a method to learn an effective continuous prompt for the stable diffusion model. This approach ensures that the generated images are engaging and contextually appropriate. Second, the GEM framework operates an iterative algorithm to generate coherent and engaging image-text pairs for a given topic of interest. This step leverages the engagement image generator that was trained in the first stage and a pre-trained text paraphrase speaker to produce well-matched and engaging image-text pairs. Experimental results and human evaluations show that the image sentence pairs generated by GEM are more engaging compared to several baselines. The novelty of our work lies in the development of a comprehensive framework that effectively addresses the challenge of generating engaging multimodal synthetic data. The following sections provide a detailed overview of related work in generation, engagement, and learnable prompts for controllable generation. The architecture and methodology behind GEM, including the engagement classifier for generation guidance, the prompt-based image generator, and the iterative image-text pair generation process are discussed in greater detail below.

The details of these and other aspects of the disclosure are set forth in the accompanying drawings and description below. Other features and advantages of the disclosure will be apparent from the drawings and description.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 shows an engagement classifier architecture for evaluating an engagement level of an image-text pair, according to aspects of the present disclosure;

FIG. 2 shows workflows for training and generating engaging multi-modal content, according to aspects of the present disclosure;

FIG. 3 shows a flow chart of an illustrative algorithm of an iterative image-text pair generation process, according to aspects of the present disclosure;

FIGS. 4A and 4B show text and image pairs generated using various methods, according to aspects of the present disclosure;

FIGS. 5A, 5B, and 5C show illustrative tables showing a comparison of models, human evaluation results, and average similarity scores, according to aspects of the present disclosure;

FIG. 6 shows an illustrative block diagram of a processor platform implementing at least a portion of an engaging multimodal content generation system, according to aspects of the present disclosure; and

FIG. 7 shows an illustrative output comparison selection interface, according to aspects of the present disclosure.

### DETAILED DESCRIPTION

Aspects of the present disclosure relate to computing methodologies such as computer vision, natural language processing, artificial intelligence, and applied computing. More particularly the present disclosure relates to a framework to generate engaging multimodal image-text pairs, with a focus on maximizing user engagement while maintaining the relevance of the content to the given topic.

### Related Work

### Generation

In recent years, there has been a significant increase in the development of large vision-and-language models capable of generating realistic objects. Generative Adversarial Networks (GANs) [9] are a popular choice for generating images based on textual descriptions, with their effectiveness demonstrated through variants such as Conditional GANs [13], Semantically Conditioned GANs [30], Wasserstein GANs [2], and Variational Autoencoder GANs [17]. Some recent approaches, like DSEGAN [12], have refined the generation process further by recomposing text features at every step of generation. Another interesting approach can be found in the architecture of Mirror GANs [32], where an image generation step is followed by a step that improves the semantic consistency of the final image-text pair via re-description.

However, GANs have limitations when it comes to handling multimodal data. This has led to the emergence of transformer-based models. Several studies have attempted to merge these two architectures together [15, 19, 42]. Researchers have also investigated an approach that relies solely on transformers to predict pixels in an auto-regressive manner [5, 6, 18]. More recently, transformer models such as DALL-E [28] and DALLE-2 [29] have been introduced, achieving state-of-the-art results in generating high-quality images that are controllable via prompts.

Another approach for image generation is based on diffusion models, which have gained popularity due to their ability to generate high-quality images with controllable attributes. The core principle behind diffusion models is to model the data distribution as a series where each step is conditioned on the previous sample. Denoising Autoencoders [40] could be considered an early type of diffusion model, as they learn to map noisy images to their clean counterparts. More recently, researchers have developed diffusion models that are directly used in image generation. One such model is the Diffusion Probabilistic Model [10], where each step is trained to gradually reverse a process of adding noise to the original image. Other notable diffusion models include the Score-Based Generative Model [38] and the Energy-Based Generative Model [8].

### Engagement

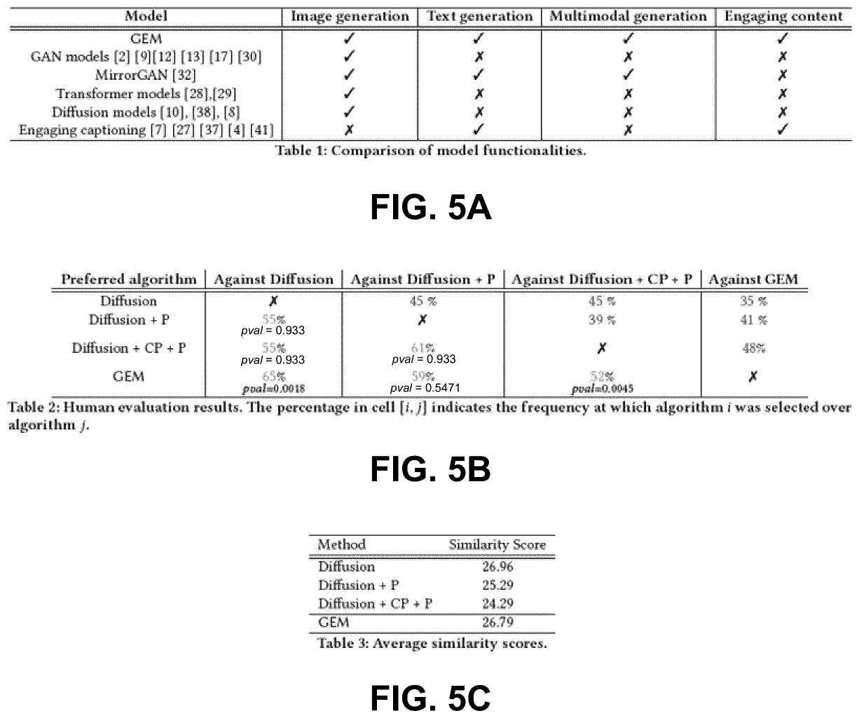

The importance of creating engaging content has increased with the advent of social media. Nevertheless, most generative models tend to overlook this aspect in favor of focusing on the fluency of generated text. Some recent studies have tried to address this issue. One possible way to achieve more engaging results is by adding emotional characteristics via sentiment analysis [27] or giving text more “personality,” as demonstrated in [7] and [37]. Another research direction concentrated on creating content with puns [4] and/or humor [41], as this tends to elicit a stronger response from viewers. In this context, we introduce a different approach where we define a classifier that helps us generate image-caption pairs with high engagement scores. Table 1, shown in FIG. 5A, presents a comparison of these introduced models.

### Learnable Prompt for Controllable Generation

As model sizes grow from millions to billions of parameters, it becomes increasingly difficult, if not impossible, to finetune the entire model end-to-end. Instead, learnable “prompting” of models has become a common practice to guide model generation/discrimination [3]. Text prompts are pieces of text inserted as a prefix into language models for steering the outputs of models. Continuous prompts are sets of learnable vectors that act as embeddings of text prompts to control the behavior of models.

In language modeling, AutoPrompt [36] uses a gradient-based search to generate prompts. Prefix-Tuning [24] concatenates continuous prompts in every layer of the model. P-Tuning [25] inserts both trainable vectors at the beginning and middle of the inputs. Perhaps the simplest and most widely used mechanism is Prompt Tuning [20], which only has k learnable tokens per downstream task. It avoids catastrophic forgetting of learned models by freezing most parameters and leaving them unchanged.

Besides language modeling, prompt learning has also been shown to be effective in computer vision [14, 44, 45], and multi-modal pretraining [22, 39]. This growing body of work demonstrates the importance and effectiveness of learnable prompts in various tasks, paving the way for a more controllable and flexible generation in vision-and-language models.

### The GEM Model

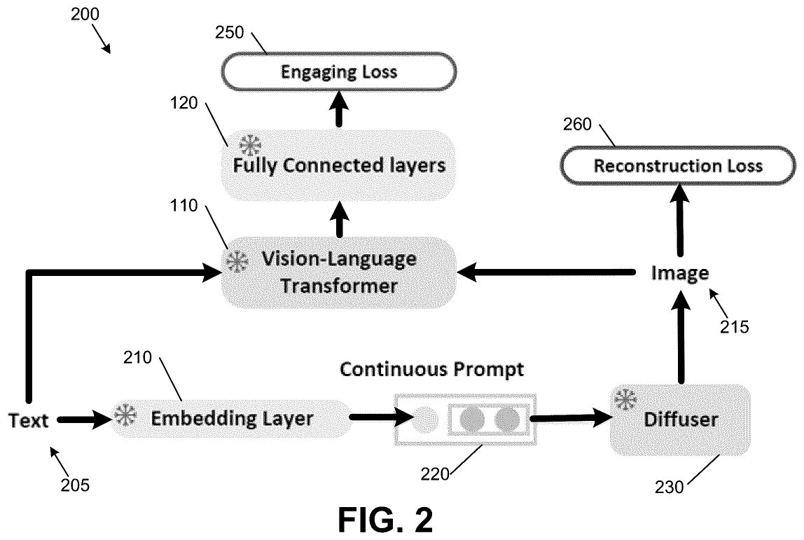

In this section, the stable diffusion model is introduced. FIG. 2 illustrates the workflows for training and generating engaging multi-modal content within the GEM framework 200. The GEM framework 200 may receive inputs (e.g., text input 205), may include one or more components including, for example, an embedding layer 210, that may generate a continuous prompt 220 to provide input to a diffuser 230. An image 215 may be generated and may be provided as input to the vision language transformer 110, along with the text 205. The fully connected layers 110 may then output information, such as an engaging loss 250. In some cases, the diffuser may output a reconstruction loss 260 when generating the image 215. Given the text, its embedding is acquired using the embedding layer 210. The continuous prompt and the text embedding are then concatenated. The image is generated by feeding the concatenated embedding into a stable diffusion model. Both the engagement loss provided by the trained engagement classifier and the reconstruction loss are used during training for a more realistic and engaging generation.

In the first step, GEM may use an image generation model trained to generate images that are both realistic and highly engaging. The second step of GEM consists of a novel iterative process for producing better-aligned multimodal image-text content by leveraging the image generator trained in the first stage for image generation and a pre-trained text paraphraser for text generation.

### Preliminaries

In some cases, the GEM method is based on the recent text-to-image Stable Diffusion (SD) model. Diffusion models define a Markov process that progressively adds Gaussian noise with variance βₜ to data before learning to reverse the diffusion process and reconstruct the data from the noise. Given the initial image data x₀ generated by the first step of GEM, the forward diffusion is computed using the formula:

$${x}_{t} = \sqrt{{\overline{α}}_{t}} {x}_{0} + \sqrt{1 - {\overline{α}}_{t}} ε \qquad ( 1 )$$

where αt=1−βt, and ϵ is sampled from a normal distribution. Stable diffusion consists of an autoencoder and a UNet denoiser. The autoencoder first converts the image x₀ into the latent space and then reconstructs it. A modified UNet [35] denoiser is used to estimate the noise ϵθ (zₜ, t, c) in the latent space, where θ refers to the parameters of the UNet denoiser, zₜ is the latent map in the time step t, which can be calculated using Equation 1. Further, c is the conditional information—in GEM, it is a text embedding method. In our setting, we have access to a pre-trained diffusion model [34]f_{diff} and an engaging multi-modal content dataset [31] with image-text-score triplets (Img, Txt, score).

### Engagement Classifier for Generation Guidance

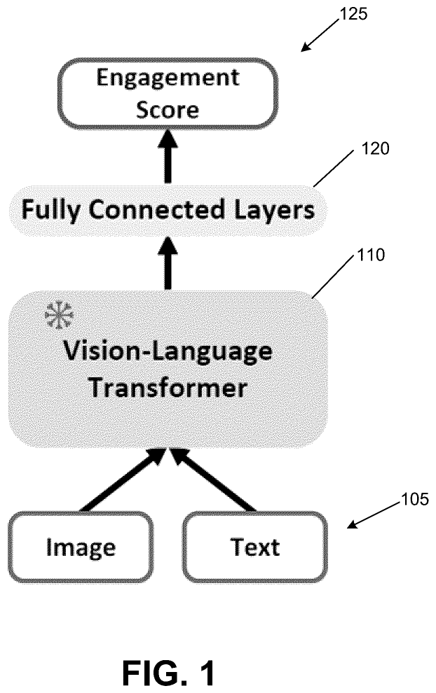

First, an “engagement” classifier is trained to provide gradient guidance to the image generator so that it generates images with high engagement scores. In particular, the engagement score is considered in the engagement dataset, as it measures how engaging the image-text pairs are and the scores are annotated by humans, which is more in line with human criteria. FIG. 1 demonstrates the architecture of the engagement classifier f_{c}. The classifier contains a pre-trained vision-language model, namely ViLT [16], to extract the multi-modal features from the text and image pairs. It is important to note that ViLT is just one example of a pre-trained vision-language model and other similar models can equivalently replace ViLT in the GEM architecture. Next, we attach a randomly initialized fully-connected module on top of ViLT to perform binary classifications. The fully-connected module consists of two fully connected layers and one activation layer between them.

The engagement classifier, denoted by f_{cls}, is trained on the engagement dataset using image-text-score triplets (Img, Txt, Score) until convergence, as illustrated in Algorithm 1 (below). The engagement scores are binarized to allow a classification task, and the cross-entropy loss is used to perform the supervised training.

Algorithm 1: Prompt-based Image Generation Training

| | |
|---|---|
| 1 | # Max_Step: Number of training steps |
| 2 | # Engage_CLS: The trained engagement classifier |
| 3 | # Embedding: Text embedding layer (FC) |
| 4 | # Diffuser: Diffusion model for image generation |
| 5 | # D_data: Dataloader for clickbait dataset |
| 6 | # D: Dataloader for image text pairs |
| 7 | # prompt: Learnable continuous prompts |
| 8 | |
| 9 | ### Pre-training a clickbait regressor (ViLT based) |
| 10 | for i in Max_Step: |
| 11 | Img, Txt, score = next(D_data) |
| 12 | L_engaging = CrossEntropy(Engage_CLS(Img,Txt), score) |
| 13 | L_engaging.backward( ) |
| 14 | Engage_CLS.update( ) |
| 15 | |
| 16 | ### Learning a Diffuser (continuous prompt learning) |
| 17 | for i in Max_Step: |
| 18 | Img, Txt, _ = next(D) |
| 19 | embed = concatenate(prompt, Embedding(Txt)) |
| 20 | I_gen = Diffuser(Img, Txt) |
| 21 | L_rec = MSE(I_gen, Img) |
| 22 | L_engaging = CrossEntropy(Engage_CLS(gen, text), 1) |
| 23 | L_total = L_rec + L_engaging |
| 24 | L_total.backward( ) |
| 25 | prompt.update( ) |
| 26 | return prompt |

### Prompt-Based Image Generator

FIG. 1 shows an engagement classifier architecture for evaluating an engagement level of an image-text pair. The engagement classifier architecture may include a vision language transformer that receives one or more input datasets, such as an image data set, a textual data set, an image/text data set and the like, one or more fully connected layers 120, and may output an output data set 125. A pre-trained vision-to-language transformer (ViLT is one example) is utilized to extract features from image and text pairs. Subsequently, fully connected layers are employed to assess the engagement level of the pairs.

A Stable Diffusion (f_{diff}) model [34] is adopted as the base image generation model for text-to-image generation. To further control the generation, a set of learnable vectors (p) is concatenated, as continuous prompts [24] and text embeddings. The output of the diffusion model I_{eng} can be denoted as follows:

$${I}_{eng} = {f}_{diff} ( z , t , Concate ( p , Emb ( Txt ) ) ) \qquad ( 2 )$$

where t is the time step uniformly sampled from 1, . . . , T, and T is the length of time steps, z∈N(0, I) is the latent map, which is the Gaussian noise. Emb( ) is the text embedding layer of diffusion model f_{diff}, and Concate denotes the concatenation operation. The dimension of p is l×d, p∈R^{l×d}, where l is the length of the continuous prompt and d is the hidden dimension size of the text embedding. Stable diffusion may use a neural network, such as by using a pre-trained contrastive language-image pretraining (CLIP) text encoder [33], and the hidden dimension size is 768. To encourage the generation of engaging images, the diffusion output I_{eng} and input Txt is forwarded to the pre-trained engagement classifier f_{c} introduced above. By increasing the positive confidence of f_{c} in predicting a generated pair (I_{eng}, Txt), the classifier f_{c} backpropagates the gradients into the diffusion model f_{diff} to produce images that are more engaging. To be precise,

$${ℒ}_{engaging} = CrossEntropy ( {f}_{c} ( {I}_{gen} , Txt ) , 1 ) , \qquad ( 3 )$$

where 1 in Equation 3 refers to the fact that the label of ((I_{eng}, Txt) is an engaging pair. In addition to the L_{engaging} loss, the standard reconstruction loss [34] is kept in the fine-tuning process of Stable Diffusion. In particular, the reconstruction loss computes the difference between the predicted noise and the original noise, as shown below:

$${ℒ}_{rec} = 𝔼 x , ε , t [ {\vert ε - fdiff ( {z}_{c} , t , e ) \vert}_{2}^{2} ] , \qquad ( 4 )$$

where zₜ is acquired by encoding the input image and x into the latent space using stable diffusion's autoencoder, which is the noisy version of x and can be calculated using ε˜N(0, I) in Equation 1, where E is the original noise, and e is the embedding of the text. Thus, the total loss for learning our prompt-based image generator is

$${ℒ}_{total} = {ℒ}_{engaging} + w \cdot {ℒ}_{rec} , \qquad ( 5 )$$

where w is the weight, which was set to 1 experimentally because the scales of these two losses are comparable. During training, as illustrated in Alg. 1, the parameters of diffusion model f_{diff} are frozen to maintain the model's ability to generate high-quality images while retaining control over the generation's engagement score. Therefore, the only learnable parameters in the framework are in p. Similar strategies have been found to be both efficient and effective in fine-tuning Transformer-based language models in NLP tasks [21, 24, 26].

### Iterative Image-Text Pair Generation

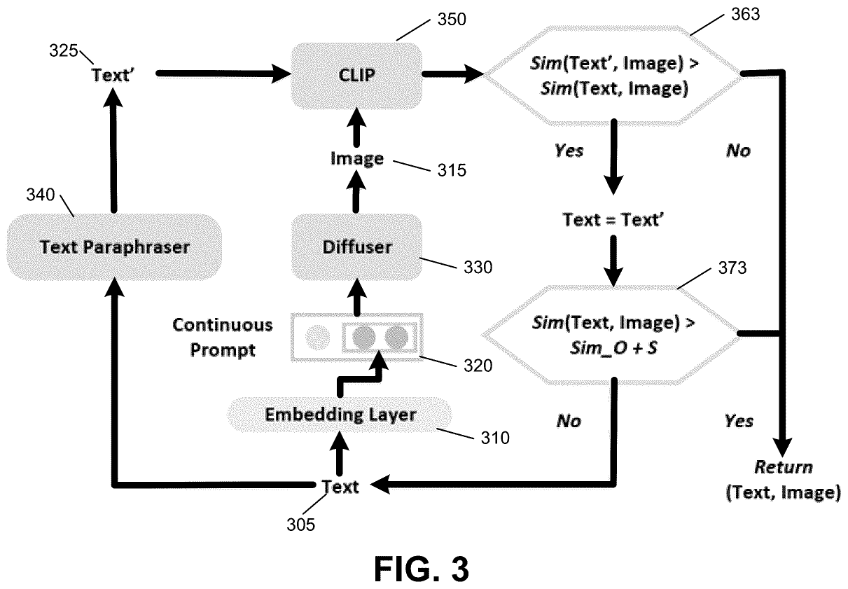

A well-aligned image and text pair requires that the image and text share substantial similarities. Based on this intuition, we devise an iterative procedure for generating the image and text pairs with the help of CLIP-based similarity scores. FIG. 3 and Algorithm 2 illustrate the full algorithm. Algorithm 2 represents an iteration generation process and FIG. 3 shows a flow chart of an algorithm of an iterative image-text pair generation process for each iteration that utilizes CLIP-based similarity scores as the criterion.

First, given the text 305, the prompt-based image generator (e.g., an embedding layer 310, a continuous prompt 320, and a diffuser 330) generates an engaging image 315, Img, and then calculates a similarity between the original text and Img as SimO, as shown in Lines 5-6 of Alg. 2. The new text, Txt′ 325, is generated using a pretrained text paraphraser 340 [43], as shown in Line 15 of Alg. 2. A pretrained CLIP model 350 is used to measure the similarity between the generated image Img and all the text, Txt, Txt′. In particular, any number of Txt′ can be generated. Experimentally, ten Txt′ instances were generated. If (Txt, Img) has the highest similarity score, then (Txt, Img) returns as the generated image and text pair, as illustrated in Lines 16-17.

If, at 363, there exists a Txt′ such that the similarity score of (Txt′, Img) is greater than the similarity score of (Txt, Img), the Txt′ with the highest similarity score is used as the new Txt, as shown in Line 11. Next, the similarity between (Txt, Img) and Sim_{O}+S is compared at 373, where S is the threshold used to constrain the similarity value to be at least S greater than the similarity of the original text and generated image. Experimentally, S was set to one. If the similarity of (Txt, Img) is greater than Sim_{O}+S, the algorithm returns (Txt, Img), as illustrated in Lines 12-13. If not, the prompt-based image generator generates a new image given the new Txt and generates text based on the new Txt, as shown in Lines 14-15. To make the algorithm more efficient and avoids the problem that the endpoint is not achieved, the maximum number of iterations is limited (e.g., the limit was set to fifty in experiments). The iterative image and text pair generation process enables this method to generate more well-aligned and engaging image and text pairs, as illustrated below.

Algorithm 2: Iterative Generation Process.

| | |
|---|---|
| 1 | T P : text paraphraser |
| 2 | T xt : Input text |
| 3 | Sim: the similarity score provided by CLIP |
| 4 | S: threshold of the termination |
| 5 | Img = f di f f (Concate (p, Emb (T xt ))) |
| 6 | Sim_O = Sim(T xt, Img) |
| 7 | T xt ′ = N one |
| 8 | for Number of iteration do |
| 9 | if Sim(T xt ′, Img) > Sim(T xt, Img) then |
| 10 | if T xt ≠ N one then |
| 11 | T xt = T xt ′ |
| 12 | if Sim(T xt, Img) > Sim_{O} + S then |
| 13 | return (T xt, Img) |
| 14 | Img = f di f f (Concate (p, Emb (T xt ))) |
| 15 | T xt ′ = T P (T xt) |
| 16 | else |
| 17 | return (T xt, Img) |
| 18 | return (T xt, Img) |

### Experiments

In experiments, the quality of the generated image and text pairs were explored by comparing the generated results to three baselines. The baselines include:
1) stable diffusion model with original sentences as input, denoted as Diffusion,
2) stable diffusion model with paraphrased sentences as inputs, denoted as Diffusion+P, and
3) stable diffusion model with the concatenation of continuous prompts and the embeddings of paraphrased sentences as input, denoted as Diffusion+CP+P.

Experiments were conducted to determine the alignment of the image and text pairs generated by different methods using CLIP similarity scores shown below in the similarity score analysis section. Additionally, a human evaluation was performed to compare (on a pair-by-pair basis) the engagement of the pairs generated by various methods. The generated pairs are displayed in the qualitative study section.

### Dataset

The engagement classifier is trained for generation guidance and continuous prompt of the stable diffusion for image generation on the Webis Corpus 2017 [31]. The Webis Corpus 2017 collects 38,517 Twitter posts published by 27 prominent US news publishers between November 2016 and June 2017. In addition to the postings, the articles linked in the posts are also included. The image and text in the post were used as the image-text pairs. Each post is scored on a 4-point scale, [0.0, 0.33, 0.66, 1.0], by 5 annotators, and the mode is used as the engagement score for this method. To avoid the problem of missing text or image in the text, 9,830 data samples are utilized in the validation set to train the continuous prompt for stable diffusion and the remaining data to train the engagement discriminator.

Five distinct topics are chosen for the experiments: crowds, vehicles, nature, architecture, and notable individuals. Initially, 25 sentences were generated for each topic using ChatGPT, a language model based on the GPT-3.5 architecture. By revising and refining these initial prompts, more engaging descriptions of the images were generated. These phrases served as the initial text prompts for the previously mentioned framework.

### Implementation Details

The pre-trained VILT [16] was employed as the vision and language Transformer for feature extraction of the image and text pairs. Following the vision and language feature extractor is a fully connected module, which consists of one fully connected layer to reduce the VILT dimension from 768 to 120, a ReLU activation layer, and a fully connected layer to predict the engagement label. The learning rate is set to 1e-3, and the engagement classifier is trained for 10 epochs with a batch size of 64. The stochastic gradient descent (SGD) optimizer was used with a momentum of 0.9. A grid search is performed for the learning rate from [1e-2, 1e-3, 1e-4].

For all experiments, the pre-trained stable diffusion v1.5 loaded from Huggingface (https://huggingface.co/runwayml/stable-diffusion-v1-5) was used. When training the learnable variable, which is the continuous prompt, its dimension was set to (prefixlength, 768). In our setting, the prefixlength=1. The default hyper-parameters provided by Huggingface were followed. The learning rate is 1e-5 with gradient accumulation steps of 4. The batch size is set to 16, and we use the Adam optimizer. During the iterative generation of image-text pairs, Pegasus [43] was used as the text paraphraser, loaded from Huggingface (https://huggingface.co/tuner007/pegasus_paraphrase). All experiments are performed using three RTX A6000 GPUs.

### Similarity Score Analysis

The similarity between image and text pairs were measured using the pre-trained CLIP model (https://huggingface.co/openai/clip-vit-large-patch14-336). Specifically, the similarity score for each of the 125 image-text pairs was computed to further obtain the mean of the similarity scores for each of the compared methods. According to Table 3 of FIG. 5C, the highest similarity score, 26.96, is achieved when only the original text and the stable diffusion model are utilized. The paraphrased text and the usage of continuous prompt decrease the similarity scores by 1.67 and 1.00, respectively, when comparing Diffusion, Diffusion+P, and Diffusion+CP+P. From Table 3, the iterative generation method was found to exhibit promising potential for increasing the similarity score. It raises the similarity score by 2.50 points compared to Diffusion+CP+P. Our GEMs similarity score is 26.79, which is comparable to the score when the original stable diffusion model is used without paraphrasing and continuous prompt. Specifically, the paraphrasing and continuous prompt techniques decrease the similarity score, and our proposed iterative method mitigates this issue. Overall, with the assistance of the iterative generation algorithm, the similarity score of the generated image and text pair is comparable to the similarity score when only the original stable diffusion model is employed.

### Human Evaluation

To further test the effectiveness of our method compared to baselines, human evaluations were conducted using Amazon Mechanical Turk (MTurk). In these evaluations, the GEM model was compared with three baselines, namely, Diffusion, Diffusion+P, and Diffusion+CP+P. The MTurk workers were paid $0.03 per task, which averages to about $15.0 per hour (as each task, on average, took 7 seconds to complete). The quality of MTurk workers was ensured by only hiring those with approval ratings equal to or above 99% and who had completed at least 10,000 tasks in the past.

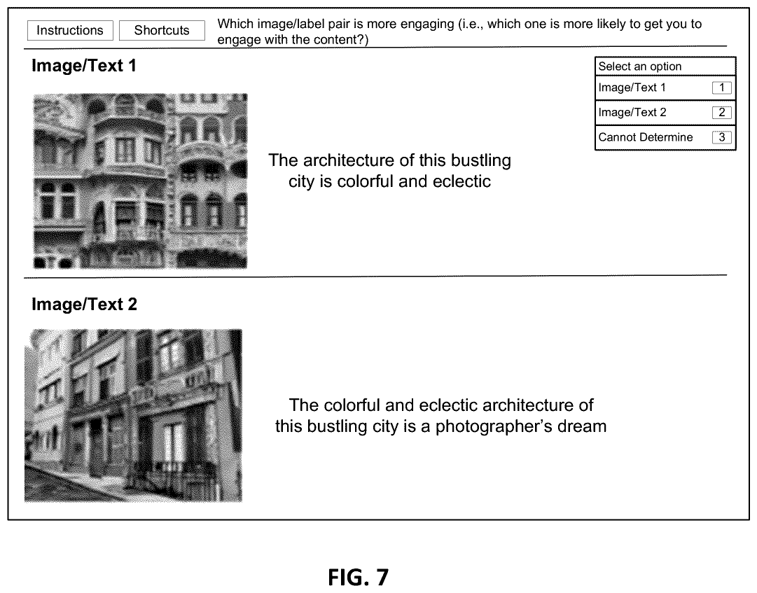

The evaluations were performed on 125 image-text generations for each of the four models (for a total of 500 unique image-text generations). As shown in FIG. 7, the comparisons are made pairwise. Overall, the workers were not informed about how the image-text pairs were generated. The order in which the data was shown to the workers was randomized to reduce bias.

The human evaluations demonstrate that our GEM can generate engaging image and text pairs, as shown in Table 2 of FIG. 5B.

From Table 2, the image and text pairs generated by the GEM framework 200 are the most engaging pairs compared to all baselines, with 15%, 9%, and 2% higher chosen times versus Diffusion, Diffusion+P, and Diffusion+CP+P, respectively. The comparisons between GEM and Diffusion, and between GEM and Diffusion+CP+P are statistically significant. By then comparing Diffusion and Diffusion+P, the technique of paraphrasing the text can enhance the engagement of the pairs. Moreover, the pairs generated by Diffusion+CP+P are more engaging than those generated by Diffusion+P, with 11% more times being selected, indicating that the continuous prompt can lead to a promising increase in engagement. Notably, although the proposed iterative generation algorithm does not guide the engaging generation explicitly, the employment of the algorithm improves the engagement, with 2% more people choosing GEM over Diffusion+CP+P. This suggests that the coherence of text-image pairs might make the pairs more attractive.

### Qualitative Study

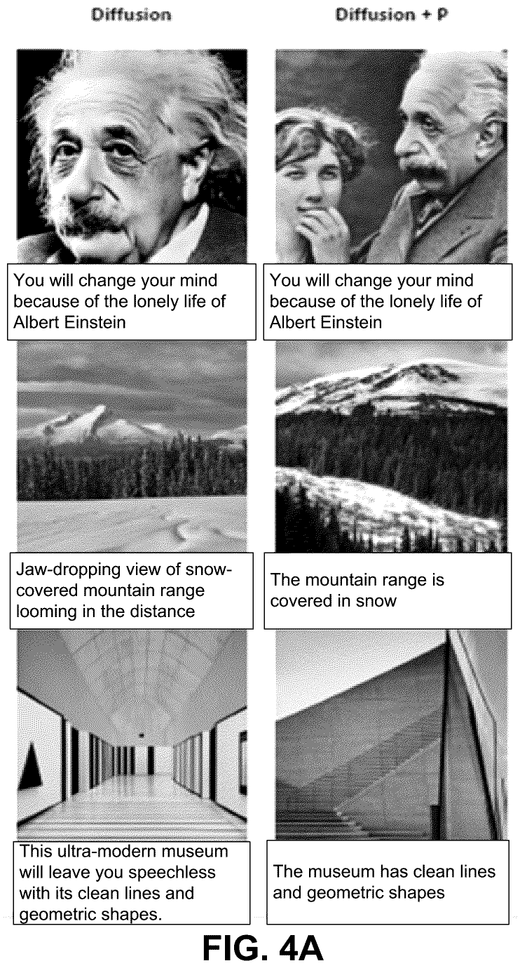

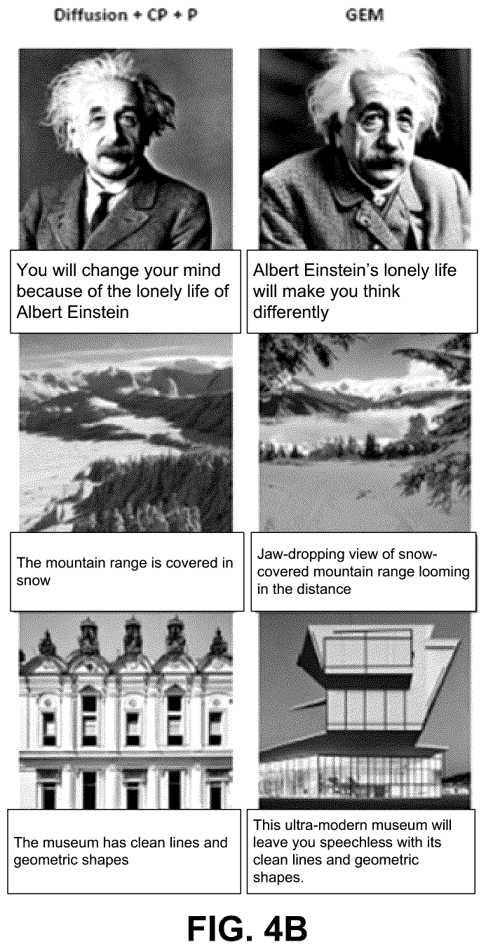

In this section, examples of image-text pairs generated by various methods are provided. FIGS. 4A and 4B show text and image pairs generated using various methods. As shown in FIGS. 4A and 4B, from left to right in each figure, the image-text pairs are generated by Diffusion, Diffusion+P, Diffusion+CP+P, and GEM, respectively. The original input sentence for each row is the input sentence for Diffusion in the first column. Notably, due to the configuration of the pre-trained paraphrase model, the paraphrased sentence may be identical to the original. The paraphrased version of the input text for GEM in the first row is more concise. The second example generated by our GEM showcases a nature scenery, which could be used for promoting tourism. To attract more people to museums, the examples in the third row are utilized. The image generated by Diffusion depicts the interior of the museum, which is not aligned with the provided text, whereas the image generated by our GEM depicts the exterior structure of the museum. Most importantly, it maintains the characteristics mentioned in the text, specifically “clean lines” and “geometric shapes”.

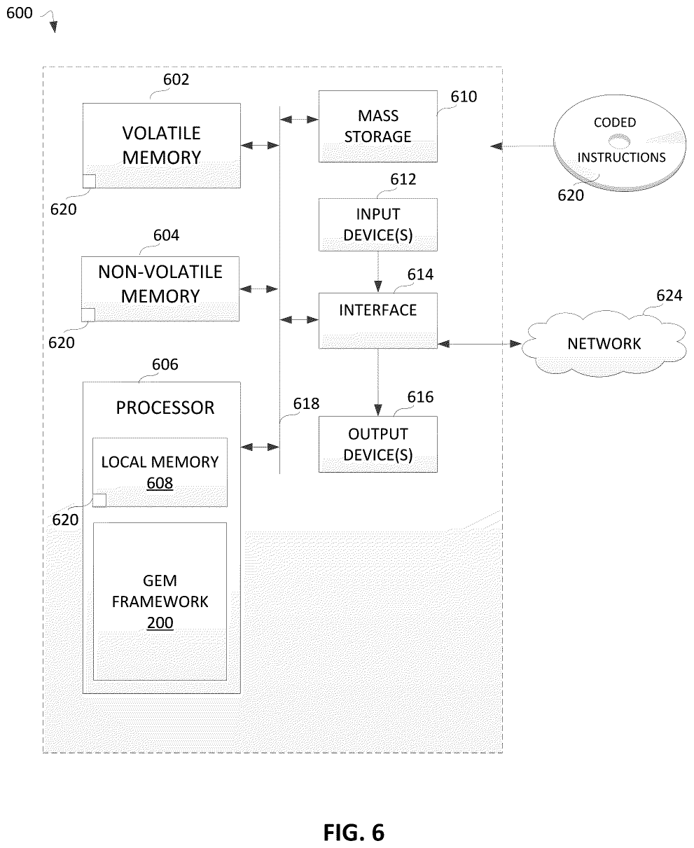

FIG. 6 shows an illustrative block diagram of a processor platform implementing at least a portion of an engaging multimodal content generation system, according to aspects of the present disclosure.

Many multimodal models [1, 11, 22, 23] today take both image and text as inputs for various downstream tasks. The GEM model, however, may take only text as input and sequentially generates images and text. Although in this scenario, a company might only have a concept for an advertisement that can be described by text, the unimodal input may make it more challenging to generate well-aligned image-text pairs.

In some cases, a framework that accepts sketches and text as optional inputs simultaneously could result in greater flexibility and better alignment of generated image and text pairs. Moreover, the engagement classifier can be utilized as a guide for any trainable modules, and our iterative generation algorithm can be more easily integrated into methods for refining the generation process.

### Computing Platform

FIG. 6 shows an illustrative block diagram of a processor platform 600 implementing at least a portion of an engaging multimodal content generation system, according to aspects of the present disclosure. The processor platform 600 may be, for example, a server, a personal computer, a mobile device (e.g., a cell phone, a smart phone, a tablet), a personal digital assistant (PDA), an Internet appliance, or any other type of computing device.

The processor platform 600 of the illustrated example includes a processor 606. The processor 606 of the illustrated example is hardware. For example, the processor 606 can be implemented by integrated circuits, logic circuits, microprocessors or controllers from any desired family or manufacture and may be distributed over one or more computing devices.

The processor 606 of the illustrated example includes a local memory 608 (e.g., a cache memory device). The illustrative processor 606 of FIG. 6 executes the instructions of at least the discussed algorithms and FIGS. 1-3 to implement the systems and infrastructure and associated methods of FIGS. 1-5C and 7 such as the illustrative engaging multimodal content generation system, etc. The processor 606 of the illustrated example is in communication with a main memory including a volatile memory 602 and a non-volatile memory 604 via a bus 618. The volatile memory 602 may be implemented by Synchronous Dynamic Random-Access Memory (SDRAM), Dynamic Random-Access Memory (DRAM), RAMBUS Dynamic Random-Access Memory (RDRAM) and/or any other type of random-access memory device. The non-volatile memory 604 may be implemented by flash memory and/or any other desired type of memory device. Access to the main memory 602, 604 is controlled by a clock controller.

The processor platform 600 of the illustrated example also includes an interface circuit 614. The interface circuit 614 may be implemented by any type of interface standard, such as an Ethernet interface, a universal serial bus (USB), and/or a PCI express interface.

In the illustrated example, one or more input devices 612 are connected to the interface circuit 614. The input device(s) 612 permit(s) a user to enter data and commands into the processor 606. The input device(s) can be implemented by, for example, a sensor, a microphone, a camera (still or video), a keyboard, a button, a mouse, a touchscreen, a track-pad, a trackball, and/or a voice recognition system.

One or more output devices 616 are also connected to the interface circuit 614 of the illustrated example. The output devices 616 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 614 of the illustrated example, thus, typically includes a graphics driver card, a graphics driver chip, or a graphics driver processor.

The interface circuit 614 of the illustrated example also includes a communication device such as a transmitter, a receiver, a transceiver, a modem and/or network interface card to facilitate exchange of data with external machines (e.g., computing devices of any kind) via a network 624 (e.g., an Ethernet connection, a digital subscriber line (DSL), a telephone line, coaxial cable, a cellular telephone system, etc.).

The processor platform 600 of the illustrated example also includes one or more mass storage devices 610 for storing software and/or data. Examples of such mass storage devices 610 include floppy disk drives, hard drive disks, compact disk drives, Blu-ray disk drives, RAID systems, and digital versatile disk (DVD) drives.

The coded instructions 620 of FIG. 6 may be stored in the mass storage device 610, in the volatile memory 602, in the non-volatile memory 604, and/or on a removable tangible computer readable storage medium such as a CD or DVD. Data processed by the instructions and/or resulting from the processed instructions may be stored in one or more memory devices, such as the mass storage device 610, in the volatile memory 602, in the non-volatile memory 604, and/or on a removable tangible computer readable storage medium.

### CONCLUSION

The GEM framework may generate engaging image and text pairs from the input text, which then can be employed by companies to attract consumers with compelling advertisements. The continuous prompt is trained under the guidance of an engagement classifier. Subsequently, an iterative algorithm may generate aligned image-text pairs using similarity scores as the criteria. Experiments on similarity scores and human evaluations demonstrate that the GEM framework generates highly engaging and well-aligned image and text pairs, which benefits the effectiveness of advertisements.

From the foregoing, it will be appreciated that the above disclosed methods, apparatus, and articles of manufacture have been disclosed to improve the functioning of a computer and/or computing device and improving analysis and computing probabilities associated with veracity of propositions in a legal matter.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

### REFERENCES

A listing of references discussed within the specification are listed below for convenience:
[1] Jean-Baptiste Alayrac, Jeff Donahue, Pauline Luc, Antoine Miech, Iain Barr, Yana Hasson, Karel Lenc, Arthur Mensch, Katherine Millican, Malcolm Reynolds, et al. 2022. Flamingo: a visual language model for few-shot learning. Advances in Neural Information Processing Systems 35 (2022), 23716-23736.
[2] Martin Arjovsky, Soumith Chintala, and Léon Bottou. 2017. Wasserstein GenerativeAdversarial Networks. In Proceedings of the 34th International Conference on Machine Learning (Proceedings of Machine Learning Research, Vol. 70), Doina Precup and Yee Whye Teh (Eds.). PMLR, 214-223. https://proceedings.mlr.press/v70/arjovsky17a.html
[3] Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al. 2020. Language models are few-shot learners. Advances in neural information processing systems 33 (2020), 1877-1901.
[4] Arjun Chandrasekaran, Devi Parikh, and Mohit Bansal. 2017. Punny captions: Witty wordplay in image descriptions. arXiv preprint arXiv:1704.08224 (2017).
[5] Mark Chen, Alec Radford, Rewon Child, Jeffrey Wu, Heewoo Jun, David Luan, and Ilya Sutskever. 2020. Generative pretraining from pixels. In International conference on machine learning. PMLR, 1691-1703.
[6] Patrick Esser, Robin Rombach, and Bjorn Ommer. 2021. Taming transformers for high-resolution image synthesis. In Proceedings of the IEEE/CVF conference on computer vision and pattern recognition. 12873-12883.
[7] Chuang Gan, Zhe Gan, Xiaodong He, Jianfeng Gao, and Li Deng. 2017. StyleNet: Generating Attractive Visual Captions with Styles. In 2017 IEEE Conference on Computer Vision and Pattern Recognition (CVPR). 955-964. https://doi.org/10.1109/CVPR.2017.108
[8] Ruiqi Gao, Yang Song, Ben Poole, Ying Nian Wu, and Diederik P Kingma. 2020. Learning energy-based models by diffusion recovery likelihood. arXiv preprint arXiv:2012.08125 (2020).
[9] Ian Goodfellow, Jean Pouget-Abadie, Mehdi Mirza, Bing Xu, David Warde-Farley, Sherjil Ozair, Aaron Courville, and Yoshua Bengio. 2020. Generative adversarial networks. Commun. ACM 63, 11 (2020), 139-144.
[10] Jonathan Ho, Ajay Jain, and Pieter Abbeel. 2020. Denoising diffusion probabilistic models. Advances in Neural Information Processing Systems 33 (2020), 6840-6851.
[11] Minghui Hu, Chuanxia Zheng, Heliang Zheng, Tat-Jen Cham, Chaoyue Wang, Zuopeng Yang, Dacheng Tao, and Ponnuthurai N Suganthan. 2022. Unified Discrete Diffusion for Simultaneous Vision-Language Generation. arXiv preprint arXiv:2211.14842 (2022).
[12] Mengqi Huang, Zhendong Mao, Penghui Wang, Quan Wang, and Yongdong Zhang. 2022. DSE-GAN: Dynamic Semantic Evolution Generative Adversarial Network for Text-to-Image Generation. In Proceedings of the 30th ACM International Conference on Multimedia. 4345-4354.
[13] Phillip Isola, Jun-Yan Zhu, Tinghui Zhou, and Alexei A Efros. 2017. Image-to image translation with conditional adversarial networks. In Proceedings of the IEEE conference on computer vision and pattern recognition. 1125-1134.
[14] Menglin Jia, Luming Tang, Bor-Chun Chen, Claire Cardie, Serge Belongie, Bharath Hariharan, and Ser-Nam Lim. 2022. Visual prompt tuning. In Computer Vision-ECCV 2022: 17th European Conference, Tel Aviv, Israel, Oct. 23-27, 2022, Proceedings, Part XXXIII. Springer, 709-727.
[15] Yifan Jiang, Shiyu Chang, and Zhangyang Wang. 2021. Transgan: Two pure transformers can make one strong gan, and that can scale up. Advances in Neural Information Processing Systems 34 (2021), 14745-14758.
[16] Wonjae Kim, Bokyung Son, and Ildoo Kim. 2021. Vilt: Vision-and-language transformer without convolution or region supervision. In International Conference on Machine Learning. PMLR, 5583-5594.
[17] Anders Boesen Lindbo Larsen, Soren Kaae Sonderby, Hugo Larochelle, and Ole Winther. 2016. Autoencoding beyond pixels using a learned similarity metric. In International conference on machine learning. PMLR, 1558-1566.
[18] Doyup Lee, Chiheon Kim, Saehoon Kim, Minsu Cho, and Wook-Shin Han. 2022. Autoregressive image generation using residual quantization. In Proceedings of the IEEE/CVF Conference on Computer Vision and Pattern Recognition. 11523-11532.
[19] Kwonjoon Lee, Huiwen Chang, Lu Jiang, Han Zhang, Zhuowen Tu, and Ce Liu. 2021. Vitgan: Training gans with vision transformers. arXiv preprint arXiv:2107.04589 (2021).
[20] Brian Lester, Rami Al-Rfou, and Noah Constant. 2021. The Power of Scale for Parameter-Efficient Prompt Tuning. In Proceedings of the 2021 Conference on Empirical Methods in Natural Language Processing. 3045-3059.
[21] Brian Lester, Rami Al-Rfou, and Noah Constant. 2021. The Power of Scale for Parameter-Efficient Prompt Tuning. In Proceedings of the 2021 Conference on Empirical Methods in Natural Language Processing. Association for Computational Linguistics, Online and Punta Cana, Dominican Republic, 3045-3059. https://doi.org/10.18653/v1/2021.emnlp-main.243
[22] Junnan Li, Dongxu Li, Silvio Savarese, and Steven Hoi. 2023. Blip-2: Bootstrapping language-image pre-training with frozen image encoders and large language models. arXiv preprint arXiv:2301.12597 (2023).
[23] Junnan Li, Ramprasaath Selvaraju, Akhilesh Gotmare, Shafiq Joty, Caiming Xiong, and Steven Chu Hong Hoi. 2021. Align before fuse: Vision and language representation learning with momentum distillation. Advances in neural information processing systems 34 (2021), 9694-9705.
[24] Xiang Lisa Li and Percy Liang. 2021. Prefix-Tuning: Optimizing Continuous Prompts for Generation. In Proceedings of the 59th Annual Meeting of the Association for Computational Linguistics and the 11th International Joint Conference on Natural Language Processing (Volume 1: Long Papers). 4582-4597.
[25] Xiao Liu, Kaixuan Ji, Yicheng Fu, Weng Tam, Zhengxiao Du, Zhilin Yang, and Jie Tang. 2022. P-tuning: Prompt tuning can be comparable to fine-tuning across scales and tasks. In Proceedings of the 60th Annual Meeting of the Association for Computational Linguistics (Volume 2: Short Papers). 61-68.
[26] Xiao Liu, Kaixuan Ji, Yicheng Fu, Weng Tam, Zhengxiao Du, Zhilin Yang, and Jie Tang. 2022. P-Tuning: Prompt Tuning Can Be Comparable to Fine-tuning Across Scales and Tasks. In Proceedings of the 60th Annual Meeting of the Association for Computational Linguistics (Volume 2: Short Papers). Association for Computational Linguistics, Dublin, Ireland, 61-68. https://doi.org/10.18653/v1/2022.acl-short.8
[27] Alexander Mathews, Lexing Xie, and Xuming He. 2016. Senticap: Generating image descriptions with sentiments. In Proceedings of the AAAI conference on artificial intelligence, Vol. 30.
[28] OpenAI. 2021. DALL-E. https://github.com/lucidrains/DALLE-pytorch
[29] OpenAI. 2022. DALL-E 2. https://github.com/lucidrains/DALLE2-pytorch
[30] Taesung Park, Ming-Yu Liu, Ting-Chun Wang, and Jun-Yan Zhu. 2019. Semantic image synthesis with spatially-adaptive normalization. In Proceedings of the IEEE/CVF conference on computer vision and pattern recognition. 2337-2346.
[31] Martin Potthast, Tim Gollub, Kristof Komlossy, Sebastian Schuster, Matti Wiegmann, rika Patricia Garces Fernandez, Matthias Hagen, and Benno Stein. 2018. Crowdsourcing a large corpus of clickbait on twitter. In Proceedings of the 27^{th} international conference on computational linguistics. 1498-1507.
[32] Tingting Qiao, Jing Zhang, Duanqing Xu, and Dacheng Tao. 2019. Mirrorgan: Learning text-to-image generation by redescription. In Proceedings of the IEEE/CVF Conference on Computer Vision and Pattern Recognition. 1505-1514.
[33] Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. 2021. Learning transferable visual models from natural language supervision. In International conference on machine learning. PMLR, 8748-8763.
[34] Robin Rombach, Andreas Blattmann, Dominik Lorenz, Patrick Esser, and Bjorn Ommer. 2021. High-Resolution Image Synthesis with Latent Diffusion Models. arXiv:2112.10752 [cs.CV]
[35] Olaf Ronneberger, Philipp Fischer, and Thomas Brox. 2015. U-net: Convolutional networks for biomedical image segmentation. In Medical Image Computing and Computer-Assisted Intervention-MICCAI 2015: 18th International Conference, Munich, Germany, Oct. 5-9, 2015, Proceedings, Part III 18. Springer, 234-241.
[36] Taylor Shin, Yasaman Razeghi, Robert L Logan IV, Eric Wallace, and Sameer Singh. 2020. AutoPrompt: Eliciting Knowledge from Language Models with Automatically Generated Prompts. In Proceedings of the 2020 Conference on Empirical Methods in Natural Language Processing (EMNLP). 4222-4235.
[37] Kurt Shuster, Samuel Humeau, Hexiang Hu, Antoine Bordes, and Jason Weston. 2019. Engaging image captioning via personality. In Proceedings of the IEEE/CVF Conference on Computer Vision and Pattern Recognition. 12516-12526.
[38] Yang Song, Jascha Sohl-Dickstein, Diederik P Kingma, Abhishek Kumar, Stefano Ermon, and Ben Poole. 2020. Score-based generative modeling through stochastic differential equations. arXiv preprint arXiv:2011.13456 (2020).
[39] Maria Tsimpoukelli, Jacob L Menick, Serkan Cabi, SM Eslami, Oriol Vinyals, and Felix Hill. 2021. Multimodal few-shot learning with frozen language models. Advances in Neural Information Processing Systems 34 (2021), 200-212.
[40] Pascal Vincent, Hugo Larochelle, Yoshua Bengio, and Pierre-Antoine Manzagol. 2008. Extracting and composing robust features with denoising autoencoders. In Proceedings of the 25th international conference on Machine learning. 1096-1103.
[41] Kota Yoshida, Munetaka Minoguchi, Kenichiro Wani, Akio Nakamura, and Hirokatsu Kataoka. 2018. Neural joking machine: Humorous image captioning. arXiv preprint arXiv:1805.11850 (2018).
[42] Bowen Zhang, Shuyang Gu, Bo Zhang, Jianmin Bao, Dong Chen, Fang Wen, Yong Wang, and Baining Guo. 2022. Styleswin: Transformer-based gan for high-resolution image generation. In Proceedings of the IEEE/CVF conference on computer vision and pattern recognition. 11304-11314.
[43] Jingqing Zhang, Yao Zhao, Mohammad Saleh, and Peter J. Liu. 2019. PEGASUS: Pre-training with Extracted Gap-sentences for Abstractive Summarization. arXiv:1912.08777 [cs.CL]
[44] Kaiyang Zhou, Jingkang Yang, Chen Change Loy, and Ziwei Liu. 2022. Conditional Prompt Learning for Vision-Language Models. In IEEE/CVF Conference on Computer Vision and Pattern Recognition (CVPR).
[45] Kaiyang Zhou, Jingkang Yang, Chen Change Loy, and Ziwei Liu. 2022. Learning to Prompt for Vision-Language Models. International Journal of Computer Vision (IJCV) (2022).

What is claimed is:

1. A computing device comprising:
a processor; and
non-transitory memory storing instructions that, when executed by the processor, cause the computing device to:
train, based on a training data set, an engagement classifier;
generate, based on gradient information from the engagement classifier, one or more images;
iteratively generate an image-text pair based on a similarity score, wherein the similarity score corresponds to a calculated similarity between original text and the one or more images; and
present, based on a final similarity score meeting a threshold, a final image-text pair.

2. The computing device of claim 1, wherein the instructions further cause the computing device to train the engagement classifier on a collection of published combinations of images and text.

3. The computing device of claim 1, wherein iteratively generating the image-text pair is limited to a maximum number of iterations.

4. The computing device of claim 1, wherein a pre-trained contrastive language-image pretraining (CLIP) model measures a similarity between a generated image and the original text.

5. The computing device of claim 1 wherein the instructions further cause the computing device to:
compare a first similarity score associated with a first text-image pair with a second similarity score associated with a second text-image pair; and
identify whether a difference between the first similarity score and the second similarity score meets a threshold condition.

6. The computing device of claim 5, wherein the instructions further cause the computing device to return, when the difference meets the threshold condition, one of the first text-image pair and the second text-image pair.

7. The computing device of claim 5, wherein the instructions further cause the computing device to generate, when the difference fails to meet the threshold condition, a third text-image pair.

8. A method comprising:
training an engagement classifier;
generating, based on gradient information from the engagement classifier, one or more images;
iteratively generating an image-text pair based on a similarity score, wherein the similarity score corresponds to a calculated similarity between original text and the one or more images; and
presenting, based on a final similarity score meeting a threshold, a final image-text pair determined from the iteratively generating step meeting a threshold.

9. The method of claim 8, wherein training of the engagement classifier comprises training on a collection of published combinations of images and text.

10. The method of claim 8, wherein iteratively generating the image-text pair is limited to a maximum number of iterations.

11. The method of claim 8, wherein a pre-trained contrastive language-image pretraining (CLIP) model measures a similarity between a generated image and the original text.

12. The method of claim 8, further comprising:
comparing a first similarity score associated with a first text-image pair with a second similarity score associated with a second text-image pair; and
identifying whether a difference between the first similarity score and the second similarity score meets a threshold condition.

13. The method of claim 12, further comprising returning, when the difference meets the threshold condition, one of the first text-image pair and the second text-image pair.

14. The method of claim 12, further comprising generating, when the difference fails to meet the threshold condition, a third text-image pair.

15. A non-transitory computer readable medium storing instructions that, when executed by a processor, cause a computing device to:
train, based on a training data set, an engagement classifier;
generate, based on gradient information from the engagement classifier, one or more images;
iteratively generate an image-text pair based on a similarity score, wherein the similarity score corresponds to a calculated similarity between original text and the one or more images; and
present, based on a final similarity score meeting a threshold, a final image-text pair.

16. The non-transitory computer readable medium of claim 15, wherein the instructions further cause the computing device to train the engagement classifier on a collection of published combinations of images and text.

17. The non-transitory computer readable medium of claim 15, wherein iteratively generating the image-text pair is limited to a maximum number of iterations.

18. The non-transitory computer readable medium of claim 15, wherein a pre-trained contrastive language-image pretraining (CLIP) model measures a similarity between a generated image and the original text.

19. The non-transitory computer readable medium of claim 15 wherein the instructions further cause the computing device to:
compare a first similarity score associated with a first text-image pair with a second similarity score associated with a second text-image pair; and
identify whether a difference between the first similarity score and the second similarity score meets a threshold condition.

20. The non-transitory computer readable medium of claim 19, wherein the instructions further cause the computing device to return, when the difference meets the threshold condition, one of the first text-image pair and the second text-image pair.
